(19) United States
(12) Patent Application Publication
(10) Pub. No.: US 2018/0258317 A1
(43) Pub. Date: Sep. 13, 2018

(54) HIGH ENERGY DRYING METHOD TO FORM A CONTINUOUS PLASTIC FILM ON A SUBSTRATE

(71) Applicant: SNP, Inc., Durham, NC (US)

(72) Inventors: Margaret Kehoe Joyce, Cary, NC (US); Thomas Tran, Raleigh, NC (US)

(73) Assignee: SNP, Inc., Durham, NC (US)

(21) Appl. No.: 15/916,316

(22) Filed: Mar. 9, 2018

Related U.S. Application Data
(60) Provisional application No. 62/469,864, filed on Mar. 10, 2017.

(51) Int. Cl. C09D 191/08; B32B 27/18; B32B 27/08; D21H 19/10; D21H 27/00; B41M 5/41

(52) U.S. Cl. CPC C09D 191/08; B32B 27/18; B41M 5/41; D21H 19/10; D21H 1/00; B32B 27/08

(57) ABSTRACT

This application is directed to methods for applying a petroleum-based thermoplastic resin (PTR) film to a substrate. A PTR emulsion or dispersion is applied to a substrate to form a PTR coating. The PTR coating is then photonically heated on the substrate. Photonically heating the PTR coating on the substrate comprises removing solvent and melting the PTR to form a continuous film.

### RELATED APPLICATION

This application claims the benefit of U.S. Provisional Application No. 62/469864 filed on Mar. 10, 2017 which is hereby incorporated by reference in its entirety.

### BACKGROUND

Paper and paperboards are extrusion coated and laminated to provide barrier properties for demanding applications, especially where the penetrant adversely affects the mechanical properties of the final product. Extrusion coating is a process where a thin layer of molten plastic is applied to the surface of paper or paperboard and chilled to solidify the plastic to the paper or paperboard surface. Common thermoplastic materials applied through this process are polyethylene (PE), polypropylene (PP), and polyethylene terephthalate (PET). These plastics provide good resistance to grease and water vapor and can be heat sealed. In some packaging structures, leak proof seals can be formed.

One of the barrier coating methods which has been under intensive research and development during recent years is dispersion barrier coating. By applying a dispersion or emulsion polymer with rod, blade, or curtain coating technologies, it is possible to offer a lower cost replacement technology for extrusion coating. Dispersion barrier coating technology could be advantageous in that it offers the possibility for the coating to be applied by the papermaker using existing on or off-machine coating equipment. With regards to aqueous thermoplastic resin coatings, however, there are challenges. One challenge limiting the utilization of aqueous thermoplastic resin (ATR) coatings is the need to evaporate off substantial amounts of water. Under prior art techniques, high energy is required to attain complete film formation of the thermoplastic resin. Normally, the temperature of the heat treatment must be higher than the melting point of the polymer for film formation. The use of high drying temperatures, however, can be detrimental to the base substrate. Blistering, yellowing, burning, or polymer degradation are examples of problems that can occur with high drying temperatures. Another problem with high drying temperatures is increased polymer tackiness. Specifically, the tackiness of the polymer increases when the polymer is above its glass transition temperature. Tacky coatings will block at the paper machine reel, rendering the product useless and causing additional labor for disposal or re-use of the product. Though the coated surface can be cooled by adding chill rolls, at the high-speed operation at which paper machines run this addition is insufficient. Further, prior art solutions like chill rolls add additional capital and operational cost to the process. In addition to these added costs, due to the high speeds at which paper machines run, a reduction in processing speed is also needed to enable sufficient cooling. Processing speeds are reduced to accommodate longer dry times at lower temperatures. Any reduction in machine speed is extremely costly due to loss in product output.

There is thus a need for an improved heat treatment method for producing barrier coated paper or board in a cost-efficient way.

The film formation of petroleum-based thermoplastic resin (PTR) dispersions or emulsions arises from the melting of individual particles normally held apart by stabilizing forces. As used herein, melting includes melting processes and inter-diffusing processes. Stabilizing forces can be overcome by the removal of the continuous phase (for example, water in an aqueous system) to bring the particles into close contact, followed by subsequent melting and flow of the melted polymer to create a continuous film. A condition of barrier properties is a continuous and pinhole free film. Numerous theories for film formation have been reported.

In the second stage of drying, the solids content increases resulting in the flocculation of the particles. As the drying process continues, there is an additional loss of water from the continuous phase. The interfacial tension at the water-air interface between the particles increases which pulls the particles into close contact with each other. They condense and begin to deform. As the particles deform, the air spaces between the particles are lost as the polymer chains inter-diffuse to form a continuous film. The formation of a continuous film is dependent on the rate of drying and the minimum film formation temperature (MFFT) of the polymer. The MFFT is related to the glass transition temperature (Tg) or to the melting point (Tm) of the polymer.

Solution processable barrier coatings can be applied and metered by many different processes. Examples of such coating methods include, but are not limited to, rod, blade, flooded nip size and metered size presses, curtain, air knife, and gravure and flexo coaters. Solution processable coating can be done in-line with the paper machine (on-line), or in a subsequent process off the paper machine (off-line). It is common for papermakers to market their paper and/or board products to printers or converters who will apply either single or multiple solution processable barrier coating layers, hot melt extruded resins, or laminates to meet the end-use requirements of their customers.

Regardless of the coating method used, the coated substrate needs to be heat treated at sufficient temperature and for adequate time to assure that a continuous film is formed. The amount of energy required to form a continuous film depends upon the amount of moisture that needs to be removed, the amount of time available to remove it, and the MFFT of the coating, which depends on the Tg or Tm of the coating. The Tg and Tm of a polymer depend on the composition of the polymer and other factors, such as degree of crystallinity, degree of crosslinking, and molecular weight. Relatively strong intermolecular forces in semi-crystalline polymers prevent softening even above the glass transition temperature. Their elastic modulus changes significantly only at a high (melting) temperature. G. W. Ehrenstein; Richard P. Theriault (2001). Polymeric materials: structure, properties, applications. Hanser Verlag. pp. 67-78. ISBN 1-56990-310-7.

Commonly used heat treatment systems for coated and/or printed paper and board all function by applying heat energy to assist in removing the continuous phase (water in the case of aqueous thermoplastic dispersions (ATP)) from the applied coating. The mass transfer of solvent from the base sheet and coating takes place simultaneously with the heat transfer process.

Heat transfer is defined as the energy in transition due to a temperature difference across two systems. During the drying process, the driving force for heat transfer is the temperature difference between the coated sheet and the ambient temperature in the dryer. Three basic mechanisms of heat transfer for the drying of coatings on paper or board are conduction, convection and radiation. At operating temperatures below 750° F. (400° C.), both conduction and convection are the major modes of heat transfer, while at higher temperatures the major mode of heat transfer is radiation. Examples of different drying processes that utilize these mechanisms of heat transfer include, but are not limited to, steam cylinder dryers (conduction), air impingement and air flotation dryers (convection), and infrared dryers (radiation).

Mass transfer occurs as mass is transported from the coating surface into the surrounding air stream during evaporation of coating moisture. The amount of mass transfer is a function of the difference in the partial pressures between the solvent in the coating and the vapor in the surrounding air. The greater this difference, the higher the driving force for evaporation. Drying starts when the partial pressure of the solvent in the coating becomes greater than the solvent vapor's partial pressure in the surrounding air. This occurs when there is sufficient heat energy applied to maintain the differential pressure to create the driving force for evaporation.

With traditional drying processes, petroleum-based thermoplastic resin coatings require long dry times and/or high heat to reach continuous film formation to obtain desirable barrier properties. This renders petroleum-based thermoplastic resin coatings unattractive. While drying time can be reduced by raising the temperature within a dryer, many of the common substrates used by papermakers and printers, are limited to how much heat they can receive due to such adverse effects as distortion, burning, yellowing, blistering, etc. that increase as the temperature increases. For example, a drying temperature of 4 minutes at 170° C. has been reported to enable the continuous film formation of ATR particles on Kraft paper, while a lower temperature drying of 122° C. for ten minutes was found to not result in continuous film formation. Continuous film formation and absence of pin holes are needed for optimum barrier performance.

Further, due to the extended drying times required to transform the particles into a continuous film, the application of petroleum-based thermoplastic dispersions is greatly limited due to the high cost of lost productivity as a result of slowing process throughput to increase residence time.

If the drying time required for continuous film formation could be reduced, petroleum-based thermoplastic resin (PTR) dispersions could be utilized with alternative application techniques, to produce thinner coatings, and would provide freedom for the formulator to produce an optimized product. Therefore, there is a need, to develop a high energy process to quickly form a thermoplastic film from solution processable petroleum-based resin coatings on substrates such as paper and film.

### SUMMARY

The present application relates to a method for the manufacture of aqueous PTR barrier coatings on paper and paperboard. The method is especially suitable for applications where coatings cannot be dried at sufficient speeds suitable for commercial processing by paper makers, printers, or converters in order to obtain adequate film formation of the PTR particles to produce desired barrier properties, including but not limited to water resistance, oil and grease resistance, water vapor transmission, gas transmissions, and other properties that petroleum-based plastics are known to impact. Other properties like adhesion and heat seal would also be beneficial. PTRs are semi-crystalline polymers that have been produced using similar methods employed to process petroleum-based thermoplastic polymers, such as those used to produce hot melt extruded papers.

The present application is directed to methods for applying a PTR film to a substrate. In one embodiment, the substrate is coated with a PTR emulsion or dispersion to form a PTR coating layer. Photonic energy is then applied to the PTR coating on the substrate to remove solvent and melt the PTR to form a continuous film. In another embodiment, the method is directed to treating a substrate constructed from paper or paperboard. A coating that includes PTR particles is applied to the substrate. The PTR particles are then photonically heated, which causes the PTR particles to rapidly melt to form a barrier layer or functional layer on the substrate.

In another embodiment, the method is directed to applying a PTR film to a substrate. The substrate is coated with PTR emulsion or dispersion to form a PTR coating layer. Energy is applied to the PTR coating on the substrate by drying the PTR coating on the substrate and then photonically heating the PTR coating on the substrate. Solvent is removed and the PTR melts to form a continuous film on the substrate.

The various aspects of the various embodiments may be used alone or in any combination, as is desired.

### BRIEF DESCRIPTION OF THE DRAWINGS

FIG. 1 is a drawing of one exemplar embodiment showing how to practice the methods described herein.

FIG. 2 is a drawing of a second exemplar embodiment showing how to practice the methods described herein.

FIG. 3 is a drawing of a third exemplar embodiment showing how to practice the methods herein.

FIG. 4 is a drawing of a fourth exemplar embodiment showing how to practice the methods described herein.

### DETAILED DESCRIPTION

The present application is directed to methods for forming a continuous petroleum-based thermoplastic resin (PTR) film. Exemplar applications for PTR polymers include non-woven fibers, hot melt extruded paperboard for drinking cups, liners for personal care products, and frozen food and ovenable packaging, all of which involve the melting and processing of PTR resin particles. Processing temperatures depend on the physical and chemical properties of the resin used.

One processing route for PTR materials is the conversion of the non-water-soluble polymer into an aqueous PTR emulsion or dispersion. As used herein, PTR emulsions and dispersions contain semi-crystalline thermoplastic resins and may or may not contain additional non-PTB constituents. The benefit of these materials over solid resin particles is that they can be utilized in such applications as paper and architectural coatings, and binders for paints and inks where the properties of PTR films are beneficial, such as water resistance, oil and grease resistance, water-vapor resistance, UV resistance and high surface energies that can benefit wetting and adhesion.

In the case of paper coatings and inks, however, the substrates to which they are applied cannot withstand the temperatures required by existing drying equipment to induce PTR film formation while maintaining or achieving product throughput. A technology capable of meeting the energy input necessary to achieve PTR films is a photonic energy emitter. Unlike conventional drying systems, a photonic energy emitting unit enables the rapid heating and drying of surface layers without adversely impacting the optical or physical properties of the coating or subsurface carrier layer.

In addition to needing energy to drive off solvent to bring the particles in close contact with one another, energy is also needed to sufficiently raise the temperature of the PTR particles to where they melt and flow to form a continuous film. Not only is energy required to raise the temperature of the solid to the melting point, but the melting itself requires heat called the heat of fusion. The force of attraction between the molecules within the PTR polymer affects the melting point of the resin particles. Stronger intermolecular interactions result in higher melting points. PTRs, through diversity of structure and chemistry, have enabled a wide range of PTR polymers of varying melting temperatures (Tm) and glass transition temperatures (Tg) to be produced.

To calculate the total drying energy required to dry a coated paper, the evaporative and sensitive heat loads for the solvent, coating, and paper must be determined and added. The sensible heat load can be calculated from the following equation:

Q_{S}32 WT/RM×S×60×SH×(T2−T1)

### Where,

Qs=Sensible heat load=Energy per foot of width (Btu/hr-ft)
WT=Basis weight (dry) of paper (lb/ream)
RM=Ream size (ft²)
S=Production speed (ft/min)
SH=Specific heat of substance (Btu/lb-ft ° F.)
T₁=Sheet temperature entering the dryer (° F.)
T2=Sheet temperature exiting the dryer (° F.)
QST=Total sensible heat load is calculated as follows:

Qₚₐₚₑᵣ+Q_{moisture in paper}+Q_{coating solids}+Q_{solvent in coating}

The evaporative heat load is calculated as follows:

EV=CW/RM×S×60×(R₁−R₂)

### Where,

EV=Solvent evaporated per foot of width (lbs/hr-ft width)
CW=Weight of PTR coating applied (Ib)
RM=Ream size (ft²)
S=Production speed (ft/min)
R₁=ratio of solvent to solids entering the dryer
R₂=ratio of solvent to solids exiting the dryer

The amount of energy to evaporate the solvent is then found using the following:

Q_{Ev=EV×Hv}

### Where,

Hv=Heat of Vaporization
   The total energy needed to dry the sheet is the sum

QₜQ_{ST}+Q_{EV}

From the above equations, it is evident how the coating, substrate, and processing conditions impact the amount of energy required to dry an applied wet film. As used herein, a substrate includes any surface on which a film can be formed. Popular substrates include, but are not limited to, paper and paperboard. In order to form a continuous PTR film on a substrate, solvent needs to be evaporated and sufficient, sufficient energy is needed to melt the PTR particles. As shown by the equations provided, this is accomplished by heating both the coating and substrate to uniform elevated temperatures beyond the maximum temperature suitable for substrate use. In the process described herein, PTR films are formed from a PTR coating, preferably an aqueous PTR coating, significantly faster than what is currently possible with conduction, convection, or infrared type dryers.

The process may comprise a xenon flash lamp that delivers a high intensity, short duration, pulse of light to dry and melt the PTR particles. Such processes may be known by the terms “photonic sintering,” “pulsed thermal processing (PTP),” and “intense pulsed light (IPL) processing.” By way of example, NovaCentrix's™ PulseForge® 3200 and Xenon™ Corporation's S5100 are each applicable pulsed light system that use xenon lamp photonic energy and that may be utilized with these inventions.

Unlike conventional drying processes, IPL emits a short pulse of high intensity energy in such a way as to prevent thermal equilibrium between particles and substrate from being achieved. As a result, a PTR coating can be rapidly heated to much higher temperatures with IPL without damaging the substrate than are possible using a conventional drying process. The higher temperatures achieved with IPL enables the PTR particles to form a film much faster and subsequently cool before any substantial heat transfer to the substrate can cause adverse heat effects. Even more importantly, rather than spending long dwell times in an oven or having to invest in additional driers which take up valuable floor space, this method can dry PTR coatings and melt PTR particles in time periods on the order of microseconds or shorter. With this technology, a coating can be processed at temperatures beyond the melting point(s) of PTR(s) on the surface of a paper or film without damaging it.

It is understood that a continuous PTR film can be obtained by heating a dried PTR coating layer to10-50° C. above the highest Tm of the PTR polymer for a period of microseconds to seconds.

The present methods may use photonic energy alone for the rapid film formation of the PTR particles. Alternatively, the methods may use photonic energy in combination with other drying methods. These methods may initially apply one or more different conventional drying methods followed by photonic energy. One specific method includes IR drying followed by applying photonic energy. Another method includes convection hot air drying followed by applying photonic energy. Still another method includes conduction drying followed by applying photonic energy. The photonic energy can be applied in different manners. This may include applying the photonic energy using high frequency-low energy pulses. This may also include using low frequency-high energy pulses. Further, the application of the photonic energy may use various combinations.

The amount of photonic energy required to form a continuous PTR film depends on the amount of photonic energy absorbed by the coating and substrate, and the amount of solvent (for example, in some embodiments, water) needed to be removed. Coatings and substrates that efficiently absorb photonic energy will require less energy to be applied to obtain a continuous film. Regardless of processing speed, the amount of IPL energy required to be applied and absorbed for a given coating-substrate pairing must be maintained to obtain the same desired coating properties. For IPL drying, the amount of energy is maintained at higher processing speeds by making changes to the physical components within the intensive pulse light unit such as increasing the number of lamps, adding a cooling system (to increase the ability to cool down the lamps), and increasing the number of capacitors.

The present methods of using IPL for the rapid film formation of PTR coatings can be applied to a variety of different substrates. These substrates include, but are not limited to, paper and paperboard products, particularly those used for the packaging, wrapping, baking, or transport of cheese, frozen foods, produce, meats, and high oil content foods such as peanut-containing products and baked goods and personal care products; disposable diapers; feminine hygiene; and disposable bed liners. The substrates may also include cups and lids, bags, and corrugated boxes used for the shipping of produce, poultry and meats.

In addition to paper and paperboard substrates, the present methods may also be used to rapidly form PTR films on low temperature plastic and bioplastic films.

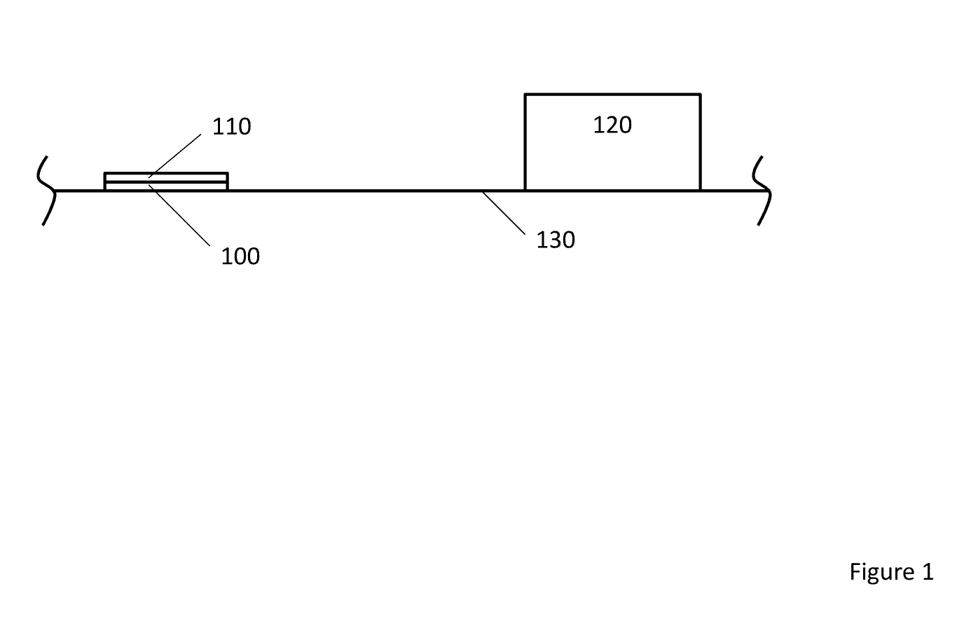

FIG. 1 schematically illustrates one exemplar process of treating a substrate 100. The substrate 100 is initially coated 110 with a dispersion of PTR particles. The coating 110 covers a limited section of the substrate 100, such as along one side or a limited section of one side or may cover an entirety of the substrate 100. In one embodiment, the PTR particle dispersion applied as a liquid may be applied through various methods. In other embodiments, the PTR particle dispersion may be applied as a solid or as a semi-solid.

Photonic energy is then applied to the coated substrate. In one embodiment, as shown in FIG. 1, the coated substrate 100 is moved along belt 130 past a photonic device 120. Other embodiments may include the photonic energy source being moved to treat the substrate. FIG. 1 includes an embodiment with the coated substrate being moved along a conveyor and past the photonic device.

The photonic device may include various configurations, such as a flash lamp or an arc lamp that emits photonic energy (e.g. pulsed light) at various frequencies and energy levels. The photonic energy speeds the drying of the coating, thus making the process more applicable for commercial applications. The photonic energy further causes a continuous PTR film to produce a barrier layer or functional layer against materials including, but not limited to, water, oil and grease, vapor resistant, and/or oxygen and gases. Further, the use of the photonic device provides for the drying and/or melting of the coating and film formation of the PTR particles without adverse thermal coating or substrate effects.

The present application relates to a process for the manufacture of PTR barrier coatings for paper and paperboard. The method is especially suitable for applications where PTR dispersions or coatings that cannot be elevated to a sufficient temperature to form a continuous PTR film at sufficient speeds suitable for commercial processing by paper makers, printers or converters in order for the PTR particles to produce the water resistance and oil and grease resistance barrier properties desired for paper and board packaging applications. The PTR can be dried and melted with a photonic energy emitting unit. Unlike conventional drying systems, a photonic energy emitting unit enables the rapid heating and drying of surface layers without adversely impacting the optical or physical properties of the coating or subsurface carrier layer.

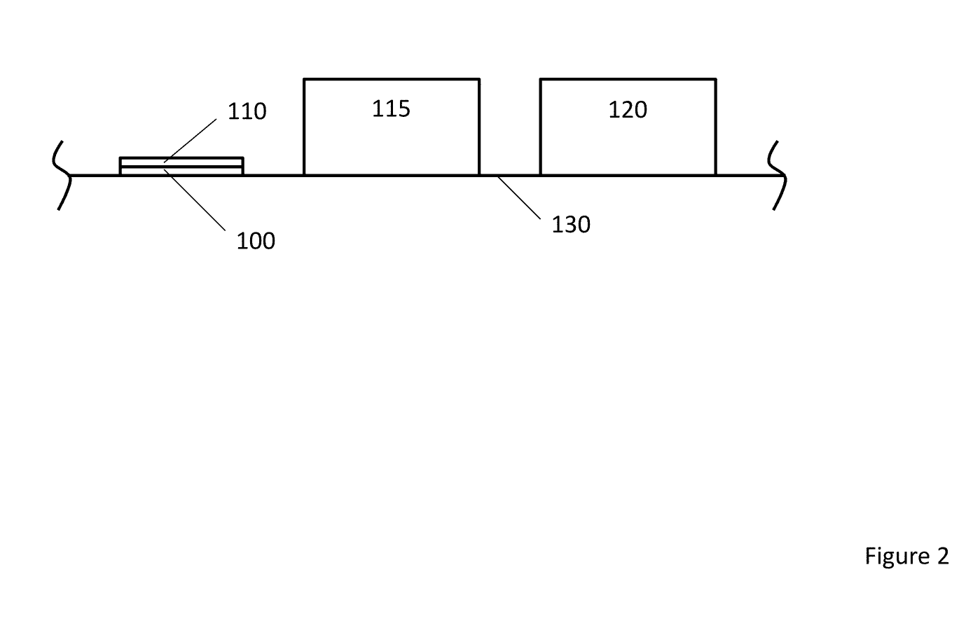

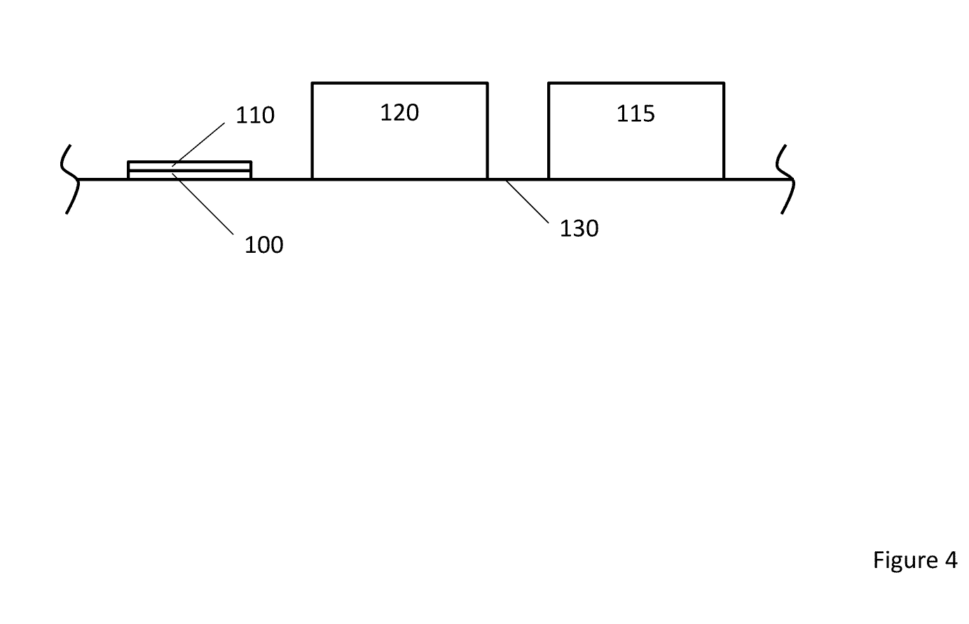

The process may also include further drying by another drying device. FIG. 2 illustrates one embodiment with a drying device 115 positioned along the conveyor. Before the coated substrate 100 is treated with photonic energy at the photonic device 120, the substrate is first treated with the drying device 115. The drying device may provide for a variety of different drying techniques through heat transfer, such as through conduction, convection, and infrared techniques. FIG. 2 includes an embodiment with the drying device 115 treating the coated substrate 100 before the photonic device 120. Other processes may include the drying device 115 treating the coated substrate 100 after the photonic device 120, which is depicted on FIG. 4. Although drying device 115 is shown as a single block in these Figures, one of skill in the art appreciates that drying device 115 may be a single device or a combination of devices. For example, in one embodiment, drying device 115 may be an infrared dryer. In another embodiment, drying device 115 may comprise a series that includes an infrared dryer and a heated calender roll. Such embodiments are intended to be non-limiting examples of drying devices 115 that may be used.

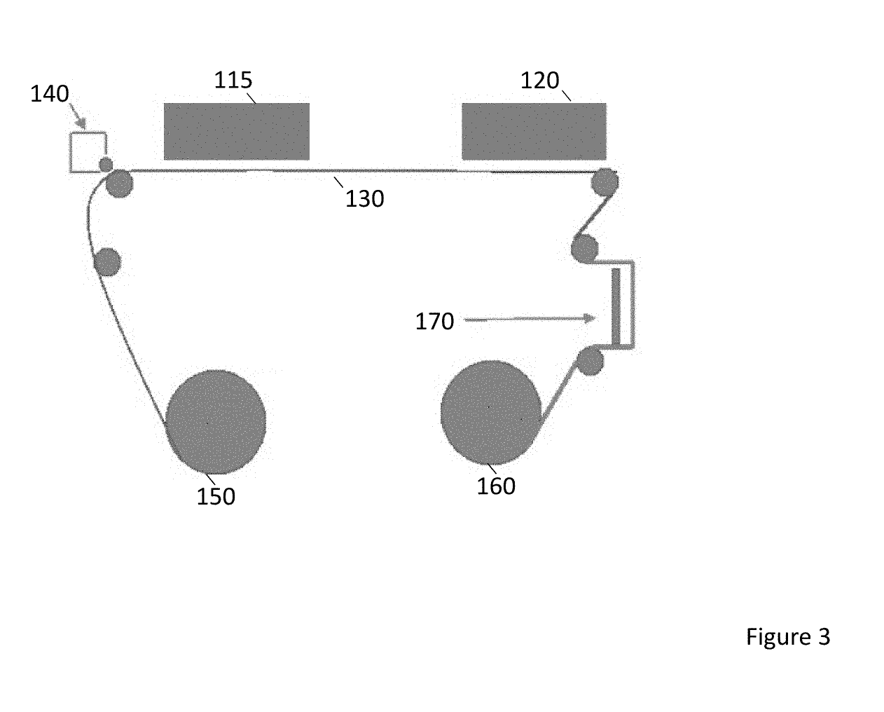

FIG. 3 shows another embodiment. A substrate is directed along a belt 130. The belt 130 includes an unwind reel 150, a wind-up reel 160, and a tension guide 170. The substrate is directed through a rod or flexo coater 140, then dried in a drying device 115, and heat treated in a photonic device 120.

By utilizing the methods described herein, it is possible to incorporate PTR coatings into industrial processes for paper and paperboard. For example, the methods herein allow for paperboard and paper coating and printing processes to continue to operate at the same speeds as traditional, aqueous paper coatings, such as, for example 1000 ft/min for paperboard and 4,000 ft/min for paper.

### EXAMPLES

An aqueous PTR coating (Canvera 110) supplied by DOW Chemical, Midland, Mich. was applied to 2 different substrates. The substrates tested were a 38 gsm bleached Kraft paper and 93 gsm unbleached Kraft paper. Coatings were applied to the base papers using various Meyer rods to obtain coat weights ranging from approximately 11 to 36 gsm. After coating, samples were dried by two different methods:

1) in a forced air-drying oven at 170° C. for four minutes; and

2) IPL using a NovaCentrix™ PulseForge® emitting a pulse between 5.43 J/cm² and 8.38 J/cm² for unbleached Kraft substrate. The overlap factor ranges 2.4-3.0. For bleached Kraft, the pulse was 7.45 J/cm² with an overlap factor of 2.4.

Forced air-drying oven conditions were chosen based on DOW technical data sheet recommendations of reaching a minimum of 170° C. peak metal temperature for 1.5 minutes. The substrates were found to reach 170° C. in less than 2.5 minutes, by infrared measurements performed on samples placed in a forced air convection oven. For these measurements a handheld IR gun was used. At least 5 temperature measurements were made. The physical properties of the material as reported by the supplier are shown in Table 1.

After drying, the water resistance was measured using the Cobb test in accordance with TAPPI standard test method T-441 see Table 2. The barrier resistance results for the photonically treated samples are in agreement with the oven dried results and those found for the oven dried treated samples produced in this work.

TABLE 1

| Property | Value |
|---|---|
| Solids Content | 42-46 |
| Viscosity | 200-1000 |
| (cP, 25° C.) | |

TABLE 2

| | Coat | Heat | Cobb | Cobb |
|---|---|---|---|---|
| | Weight | Treatment | Duration | Value |
| Substrate | (±1 gsm) | Method | (minutes) | (gsm) |
| Bleached | 12 | Oven | 20 | 2.3 |
| Kraft | | | | |
| Bleached | 11 | IPL | 20 | 3.1 |
| Kraft | | | | |
| Bleached | 17 | Oven | 20 | 1.3 |
| Kraft | | | | |
| Bleached | 18 | IPL | 20 | 1.3 |
| Kraft | | | | |
| Bleached | 36 | Oven | 20 | 1.7 |
| Kraft | | | | |
| Bleached | 31 | IPL | 20 | 0.7 |
| Kraft | | | | |
| Unbleached | 11 | Oven | 2 | 4.5 |
| Kraft | | | | |
| Unbleached | 12 | IPL | 2 | 7.6 |
| Kraft | | | | |
| Unbleached | 20 | Oven | 2 | 6.2 |
| Kraft | | | | |
| Unbleached | 20 | IPL | 2 | 4.8 |
| Kraft | | | | |
| Unbleached | 33 | Oven | 2 | 2.4 |
| Kraft | | | | |
| Unbleached | 33 | IPL | 2 | 1.8 |
| Kraft | | | | |

The lamp to platen was set to between 4 to 15 mm below the window. The coated surface was similar to what was observed for the 170° C., 4-minute oven.

In a second study, the aqueous PTR coating (Arrow Base 4010) supplied by Unitika, was applied to 2 different substrates. The substrates tested were a 38 gsm bleached Kraft paper and 93 gsm unbleached Kraft paper. Coatings were applied to the base papers using various Meyer rods to obtain coat weights ranging from approximately 5 to 19 gsm. After coating, samples were dried by two different methods:

1) in a forced air-drying oven at 170° C. for four minutes; and

2) IPL using a NovaCentrix™ PulseForge® emitting a pulse between 4.56 J/cm² and 6.05 J/cm² for unbleached Kraft substrate. The overlap factor ranges 2.0-3.0. For bleached Kraft, the pulse was 7.45 -8.44 J/cm² with an overlap factor of 2.4.

Forced air-drying oven conditions were chosen based on Arrow Base 4010 melting point of 140-150° C. As previously mentioned, the temperature should be 10-50° C. above the polymer melting.

After drying, water resistance was measured as above, see Table 3. The results for the photonically treated samples are in agreement with the oven dried results and those found for the oven dried treated samples.

The physical properties of the material as reported by the supplier are shown in Table 4.

TABLE 3

| | Coat | Heat | Cobb | Cobb |
|---|---|---|---|---|
| | Weight | Treatment | Duration | Value |
| Substrate | (+/−1 gsm) | Method | (minutes) | (gsm) |
| Bleached | 9 | Oven | 20 | 16.0 |
| Kraft | | | | |
| Bleached | 8 | IPL | 20 | 17.9 |
| Kraft | | | | |
| Bleached | 11 | Oven | 20 | 16.8 |
| Kraft | | | | |
| Bleached | 12 | IPL | 20 | 18.0 |
| Kraft | | | | |
| Bleached | 16 | Oven | 20 | 15.2 |
| Kraft | | | | |
| Bleached | 19 | IPL | 20 | 20.1 |
| Kraft | | | | |
| Unbleached | 7 | Oven | 2 | 10.2 |
| Kraft | | | | |
| Unbleached | 5 | IPL | 2 | 11.8 |
| Kraft | | | | |
| Unbleached | 13 | Oven | 2 | 7.3 |
| Kraft | | | | |
| Unbleached | 13 | IPL | 2 | 5.9 |
| Kraft | | | | |
| Unbleached | 18 | Oven | 2 | 1.0 |
| Kraft | | | | |
| Unbleached | 18 | IPL | 2 | 2.4 |
| Kraft | | | | |

TABLE 4

| Property | Value |
|---|---|
| Melting Point (° C.) | 140-150 |
| Solids Content (%) | 25 |
| Viscosity | 3-50 |
| (cP, 25° C.) | |

In the third study, the aqueous S-8000-Q PTR coating containing a mixture of polyolefin and polyester particles supplied by SNP Inc., was applied to 2 different substrates. The substrate tested was a 93 gsm unbleached Kraft paper. Coatings were applied to the base papers using various Meyer rods to obtain coat weights ranging from approximately 5 to 31 gsm. After coating, samples were dried by two different methods:

1) in a forced air-drying oven at 170° C. for four minutes; and

2) IPL using a NovaCentrix™ PulseForge® emitting a pulse between 5.43 J/cm² and 6.05 J/cm² for unbleached Kraft substrate. The overlap factor ranges 2.4-3.0.

Forced air-drying oven conditions were chosen based on melting point of the polymers. As previously mentioned, the temperature should be 10-50° C. above the polymer melting therefore forced air-drying oven at 170° C. for four minutes was selected.

After drying, water resistance of the coated samples was measured as above and the oil and grease resistance measured using the 3M Kit test in accordance with TAPPI standard test method T-559 see Table 5. The barrier resistance results for the photonically treated samples are in agreement with the oven dried results. The kit values showed improvement in oil and grease resistance with photonic treatment.

TABLE 5

| | Coat | Heat | Cobb | Cobb | |
|---|---|---|---|---|---|
| | Weight | Treatment | Duration | Value | Kit |
| Substrate | (+/−1 gsm) | Method | (minutes) | (gsm) | Value |
| Unbleached | 9 | Oven | 2 | 0.4 | 0 |
| Kraft | | | | | |
| Unbleached | 12 | IPL | 2 | 2.1 | 3 |
| Kraft | | | | | |
| Unbleached | 18 | Oven | 2 | 3.5 | 0 |
| Kraft | | | | | |
| Unbleached | 19 | IPL | 2 | 5.7 | 2 |
| Kraft | | | | | |
| Unbleached | 33 | Oven | 2 | 3.0 | 4 |
| Kraft | | | | | |
| Unbleached | 29 | IPL | 2 | 0.3 | 6 |
| Kraft | | | | | |

The physical properties of the material as reported by the supplier are shown in Table 6.

TABLE 6

| Property | Value |
|---|---|
| Solids Content (%) | 42 |
| Viscosity | 140 |
| (cP, 25° C.) | |

In the fourth study, various coatings were applied to a 50 gsm clay coated bleached Kraft substrate with various Meyer rods. After PTR coating, samples were dried by two different methods:

1) in a forced air-drying oven at 170° C. for four minutes; and

2) IPL using a NovaCentrixTM PulseForge® emitting a pulse of 15.6 J/cm² for bleached Kraft substrate with a overlap factor of 2.4.

Forced air-drying oven conditions were chosen based on melting point of the polymers. As previously mentioned, the temperature should be 10-50° C. above the polymer melting therefore forced air-drying oven at 170° C. for four minutes was selected.

After drying, the oil and grease resistance properties of the coated samples were measured as above see Table 7. Water repellency was measured in accordance with TAPPI test method RC-212. The barrier resistance results for the photonically treated samples are in agreement with the oven dried results. The kit values showed improvement in oil and grease resistance with the photonically treated.

TABLE 7

| | Ct. Wt. | Heat | Kit | Water |
|---|---|---|---|---|
| | (gsm) | Treatment | Value | Drop |
| Uncoated | 0 | none | 4 | 0 |
| Basepaper | | | | |
| Arrowbase 4010 | 5.0 + .5 | Oven | 7 | 5 |
| | | IPL | 9 | 5 |
| Arrowbase 1010 | 3.0 + .5 | Oven | 7 | 5 |
| | | IPL | 10 | 5 |
| Canvera 1110 | 7.0 + 1 | Oven | 7 | 5 |
| | | IPL | 11 | 5 |

In the fifth study, various coatings were applied to a 50 gsm clay coated bleached Kraft substrate with various Meyer rods. After PTR coating, samples were dried by two different methods:

1) in a forced air-drying oven at 170° C. for four minutes; and

2) IPL using a NovaCentrix™ PulseForge® emitting a pulse between 14.8 J/cm² and 15.6 J/cm² for bleached Kraft substrate with an overlap factor of 2.4.

Forced air-drying oven conditions were chosen based on melting point of the polymers. As previously mentioned, the temperature should be 10-50° C. above the polymer melting therefore forced air-drying oven at 170° C. for four minutes was selected.

After drying, oil and grease resistance and water vapor transmission rate (WVTR) properties of the coated samples were measured in accordance with TAPPI standard test method T-559 and T-448 at 23° C., 50% RH, respectively, see Table 8. The barrier resistance results for the photonically treated samples are in agreement with the oven dried results. The kit values showed improvement in oil and grease resistance with the photonically treated. The water vapor rates were tested and are similar in comparison between the forced air-oven dried and IPL.

TABLE 8

| | Ct Wt. | Heat | Kit | Water | WVTR |
|---|---|---|---|---|---|
| | (gsm) | Treatment | Value | Drop | (g/m²/day) |
| Basepaper | 0 | none | 4 | 0 | 52.57 |
| Arrowbase 4010 | 4.2 | Oven | 9 | 5 | 5.68 |
| | | IPL | 8 | 5 | 6.11 |
| Arrowbase 1010 | 5.0 | Oven | 6 | 5 | 5.20 |
| | | IPL | 8 | 4.5 | 5.82 |
| Canerva | 3.6 | Oven | 12 | 5 | 3.41 |
| | | IPL | 12 | 4.5 | 2.90 |
| Arrowbase 4010 | 5.3 | Oven | 7 | 5 | 8.72 |
| | | IPL | 9 | 5 | 5.67 |
| Arrowbase 1010 | 3.0 | Oven | 7 | 5 | 5.52 |
| | | IPL | 10 | 5 | 6.57 |
| Canerva | 7.1 | Oven | 7 | 5 | 1.07 |
| | | IPL | 11 | 5 | 1.22 |

As used herein, spatially relative terms such as “under”, “below”, “over”, “upper,” and the like are used for ease of description to explain the positioning of one element relative to a second element. These terms are intended to encompass different orientations of the device in addition to different orientations than those depicted in the figures. Further, terms such as “first,” “second,” and the like are also used to describe various elements. Regions, sections, etc. are also not intended to be limiting. Like terms refer to like elements throughout the description.

As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise.

The methods of treating a PTR coating on the substrate comprise delivering high intensity pulses of light from a xenon flash lamp to the PTR. The present invention may be carried out in other specific ways than those herein set forth without departing from the scope and essential characteristics of the invention. The present embodiments are, therefore, to be considered in all respects as illustrative and not restrictive.

What is claimed is:

1. A method for applying a petroleum-based thermoplastic resin (PTR) film to a substrate, the method comprising:
applying an aqueous PTR emulsion or dispersion to a substrate to form a PTR coating; and
photonically heating the PTR coating on the substrate, wherein photonically heating the PTR coating on the substrate comprises removing solvent and melting the PTR to form a continuous film.

2. The method of claim 1, further comprising photonically heating the PTR coating on the substrate by delivering high intensity pulses of light from a xenon flash lamp.

3. The method of claim 1, further comprising drying the PTR coating on the substrate.

4. The method of claim 3, wherein drying the PTR coating on the substrate occurs prior to photonically heating the PTR coating on substrate.

5. The method of claim 3, wherein drying the PTR coating on the substrate occurs after photonically heating the PTR coating on the substrate.

6. A method for treating a substrate constructed from paper or paperboard comprising:
coating a substrate with a solution comprising PTR particles and forming a PTR coating;
photonically heating the PTR coating and melting the PTR particles to form a functional layer on the substrate.

7. The method of claim 6, wherein photonically heating the PTR coating comprising moving the substrate with the PTR coating relative to a light source.

8. The method of claim 6, further comprising drying the PTR coating using convection, conduction, IR drying, or combinations thereof.

9. The method of claim 6, wherein the substrate comprises paper or paperboard.

10. A method for applying a PTR film to a substrate, the method comprising:
applying an aqueous PTR coating to the substrate;
removing solvent; and
melting the PTR to form a continuous film on the substrate.

11. The method of claim 10, further comprising drying the PTR coating on the substrate prior to photonically heating the PTR coating on the substrate.

12. The method of claim 10, further comprising drying the PTR coating on the substrate after photonically heating the PTR coating on the substrate.
